(19) United States
(12) Patent Application Publication
(10) Pub. No.: US 2007/0028254 A1
(43) Pub. Date: Feb. 1, 2007

(54) Optical disc apparatus

(75) Inventors: Hideyuki Onuma, Kuala Lumpur (MY); Sojiro Kirihara, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/370,084

(22) Filed: Mar. 6, 2006

(30) Foreign Application Priority Data
Jul. 28, 2005 (JP) 2005-218460

(51) Int. Cl. G11B 7/00

(52) U.S. Cl. 720/673

(57) ABSTRACT

An optical disc apparatus which has a lock mechanism including a hook to engage with an optical pickup's part which is to be locked. It also has a lock member which turns around a fulcrum as a sliding member slides when an optical disc is loaded or unloaded. When the sliding member is not in touch with the lock member, the hook turns in a direction to engage with the part to be locked and locks the optical pickup, and when the sliding member is in touch with it, the hook turns in a direction to disengage from the part to be locked and unlocks the optical pickup. This improves impact resistance when a disc is unloaded.

### CLAIM OF PRIORITY

The present application claims priority from Japanese application serial No. P2005-218460, filed on Jul. 28, 2005, the content of which is hereby incorporated by reference into this application.

### BACKGROUND OF THE INVENTION

1. Field of the Invention

The present invention relates to an optical disc apparatus and more particularly to a structure which prevents damage to a apparatus in transportation by locking an optical pickup while no optical disc is loaded.

2. Description of the Related Art

Among techniques related to the present invention is the one disclosed in JP-A No. 339880/2000. This gazette describes a structure in which, when a disc drive section having a turntable and an optical pickup is in its standby position, a limiting piece provided on the optical pickup is limited by a side wall surface of a projection formed on a bottom chassis so as to limit the movement of the optical pickup.

However, as apparent from an illustration of the structure, the prior art described in JP-A No. 339880/2000 is intended to be applied to an optical disc apparatus (for example, a half-height model) whose thickness may be approx. 25×10⁻³ m or more, where the projection is located at a disc innermost side position remotely from the fulcrum of vertical motion of the disc drive section (unit mechanical part) so that the optical pickup is locked or unlocked at that position. The conventional structure can be embodied only when the disc drive section (unit mechanical part) can move up and down at the projection sufficiently. Therefore, in a certain type of optical disc apparatus in which the disc drive section cannot be moved up and down sufficiently, such as a slim slot drive model, there are many difficulties in embodying the prior art.

FIG. 5 shows an example of a structure in which the above prior art is introduced into a slim slot drive model and a projection is provided so as to allow the unit mechanical part to move up and down sufficiently to unlock the optical pickup for disc loading. A pickup stopper 200 as the projection is provided on the inner surface of a bottom case 20 at a position that makes it possible to unlock the pickup as mentioned above. When a disc is unloaded (no disc is loaded), an optical pickup 13 is at the disc outermost side position near the fulcrum of vertical motion with the unit chassis 50 down on the bottom case 20 and the optical pickup 13 is away from the pickup stopper 200 by distance L. If an impact should be given in this condition, for example, during transportation, the optical pickup 13 would move toward the pickup stopper 200 and might collide against the pickup stopper 200 and break. In FIG. 5, numeral 11 represents a disc motor; 12 represents a turntable; 30 represents a slide motor for rotating a lead screw 31; and 40 represents a loading motor for loading an optical disc.

The present invention has been made in view of the above circumstances of the prior art and concerns a simple structure for a slim slot drive type optical disc apparatus or the like in which, when a disc is unloaded, an optical pickup is locked to prevent damage to it upon impact.

The primary object of the invention is to provide a reliable optical disc apparatus which solves the above problem.

### SUMMARY OF THE INVENTION

The present invention offers a technique which solves the above problem.

According to the present invention, in an optical disc apparatus, a lock mechanism which locks an optical pickup when an optical disc is unloaded, and unlocks the optical pickup when the optical disc is loaded, includes a lock member which has a hook to engage with the optical pickup's part to be locked and turns around a fulcrum depending on a sliding member which slides when an optical disc is loaded or unloaded. When the sliding member is not in touch with the lock member, the hook turns in a direction to engage with the part to be locked and locks the optical pickup, and when the sliding member is in touch with it, the hook turns in a direction to disengage from the part to be locked and unlocks the optical pickup.

According to the present invention, in an optical disc apparatus, an optical pickup is protected from impact, etc. in transportation or a similar situation by a simple structure so that reliability of the apparatus is improved.

### BRIEF DESCRIPTION OF THE DRAWINGS

FIG. 1 shows an example of a structure of a front side of an optical disc apparatus according to an embodiment of the present invention;

FIG. 2 shows an example of a back side of the optical disc apparatus of FIG. 1;

FIG. 3 shows a lock mechanism of an optical pickup of the optical disc apparatus of FIG. 1;

FIGS. 4A and 4B are flowcharts explaining operational sequences of the lock mechanism of FIG. 3 where FIG. 4A shows a disc unloading process and FIG. 4B shows a disc loading process; and

FIG. 5 illustrates the problem to be solved by the present invention.

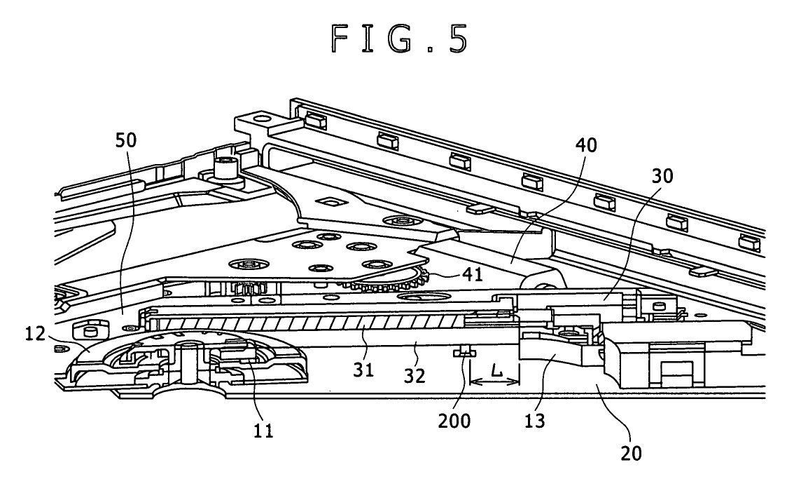

### DETAILED DESCRIPTION OF THE PREFERRED EMBODIMENT

Next, a preferred embodiment of the present invention will be described referring to the accompanying drawings.

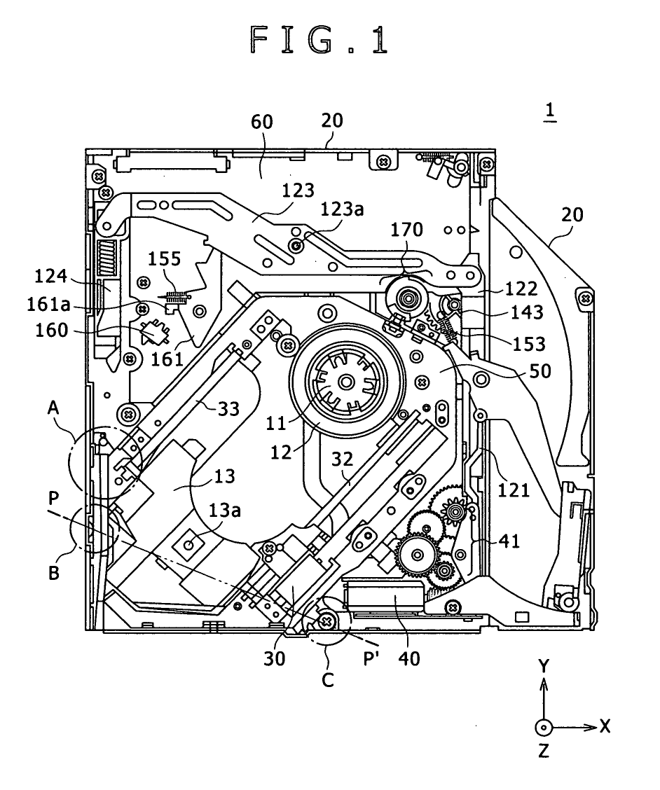

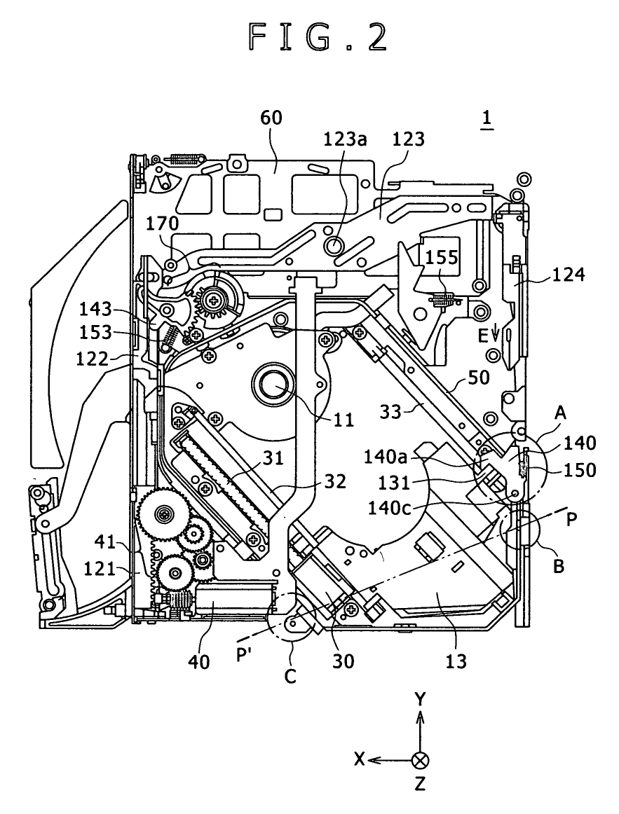

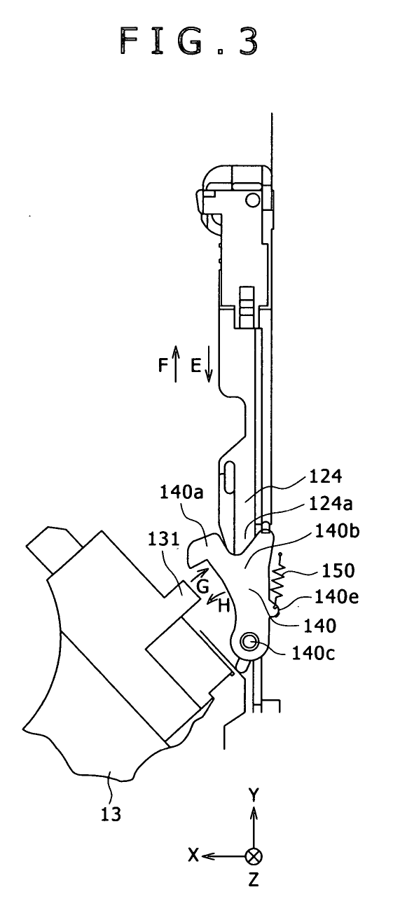

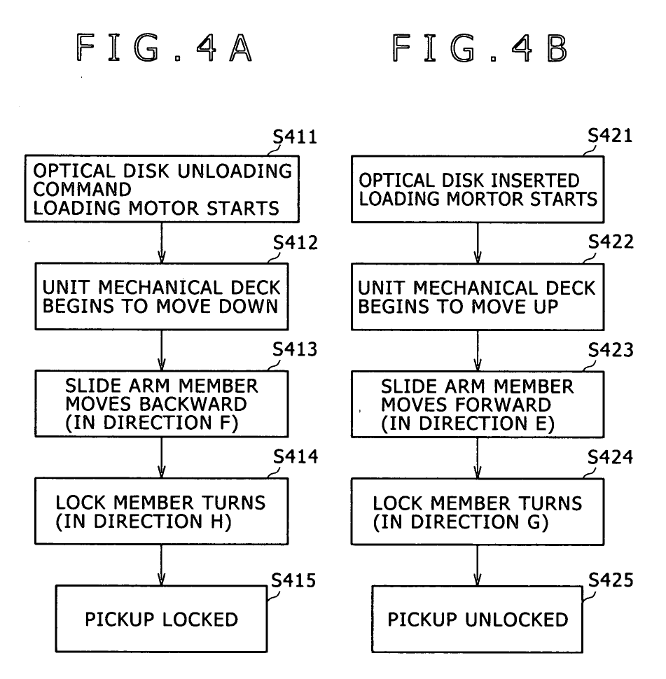

FIG. 1 to FIG. 4B are explanatory drawings for an embodiment of the invention. FIGS. 1 and 2 show the general structure of an optical disc apparatus according to the embodiment of the invention; FIG. 3 shows the structure of a lock mechanism of an optical pickup of the optical disc apparatus as shown in FIGS. 1 and 2; and FIGS. 4A and 4B explain operational sequences of the lock mechanism of FIG. 3. In FIGS. 1 to 3, the same constituent elements are designated by the same reference numerals and the same coordinate axes are used.

FIG. 1 shows an example of a structure of a front side (disc loading side) of the optical disc apparatus according to the embodiment of the present invention; and FIG. 2 shows an example of a structure of a back side (opposite of the disc loading side) of the apparatus.

In FIG. 1, numeral 1 represents an optical disc apparatus; 11 represents a disc motor which rotates an optical disc (not shown); 12 represents a turntable on which an optical disc rests; 13 an optical pickup; 13a represents an objective lens; 20 represents a bottom case which covers the back side of the optical disc apparatus 1; 31 represents a lead screw member with a threaded surface which moves the optical pickup in a virtually radial direction of an optical disc (not shown) by rotation of the thread; 30 represents a feed motor which rotates the lead screw member 31; 32 and 33 represent guide members which guide movement of the optical pickup 13; 60 represents a base member as a apparatus platform; 50 represents a unit mechanical deck which bears the abovementioned disc motor 11, optical pickup 13, feed motor 30, lead screw member 31, guide members 32 and 33 and so on and can move up and down with respect to the base member 60; 121, 122 and 123 represent lever members which, when an optical disc is inserted into the apparatus from the front panel (not shown) in the Y-axis direction and when an optical disc is unloaded from the apparatus toward the front panel, transmit driving power for the insertion and unloading; 123a represents a turn fulcrum for the lever member 123; 124 represents a slide arm member connected to the lever member 123; 40 represents a loading motor; 160 represents a switch which turns on and off the driving power to the loading motor 40; 161 represents a switch activating arm member which activates the switch 160; 155 represents a spring which biases the switch activating arm member 161; 161a represents a switch contact of the switch activating arm member 161; 41 represents a transmission which transmits the rotary driving power of the loading motor 40 to the lever member 121; 170 represents a lifting mechanism, located on the base member 60, which, during loading of an optical disc, moves up and down the unit mechanical deck 50 with the optical disc in place in the apparatus; 143 represents an arm member which transmits driving power to the lifting mechanism 170; 153 represents a spring which biases the arm member 143; A represents an area (hereinafter called the lock mechanism for the sake of simplicity) where there is a lock mechanism which locks the optical pickup 13 to make it unmovable when a disc is unloaded; B and C represent locations of fulcrums of vertical motion for the unit mechanical deck 50 (hereinafter called the fulcrums of vertical motion for the sake of simplicity); and line PP′ represents a line which connects the fulcrums of vertical motion B and C (hereinafter called the fulcrum line). While the unit mechanical deck 50 moves up or down, it turns around the fulcrum line PP′.

In FIG. 2, numeral 140 represents a lock member which locks the optical pickup 13 into a specified position (disc unloading position) inside the optical disc apparatus in the lock mechanism A (with no disc loaded); 140a represents a hook for the lock member 140; 140c represents a turn fulcrum for the lock member 140; 140d represents a recessed surface of the lock member 140; 150 represents a spring which biases the lock member 140 in the counterclockwise direction with respect to the turn fulcrum 140c; 131 represents a projection on the pickup 13 as a part to be locked; and arrow E represents the direction of movement of the slide arm member 124. Other numerals and symbols are the same as those shown in FIG. 1. The lock member 140 turns around the turn fulcrum 140c in a plane virtually parallel to the rotation plane of the optical disc. The transmission 41 consists of a gear train.

In the above lock mechanism A, when the lock member 140 is out of touch with or in touch with the slide arm member 124, it locks or unlocks the optical pickup 13 respectively. Specifically, when the optical disc loaded in the optical disc apparatus 1 is released, or unloaded, the slide arm member is released from the recessed surface 140d of the lock member 140 and moved back toward the direction opposite to the direction of arrow E. As the lock member 140 is released from the slide arm member 124, it turns around the turn fulcrum 140c counterclockwise and engages the hook 140a with the projection 131 of the optical pickup 13 at the disc unloading position and locks the optical pickup 13. On the other hand, when the optical disc is inserted into the optical disc apparatus 1 and loaded, the slide arm member 124 moves forward in the direction of arrow E and comes into touch with the recessed surface 140d of the lock member 140. When the lock member 140 touches the slide arm member 124, it receives an external force from the slide arm member 124 and turns around the turn fulcrum 140c clockwise; and upon completion of disc loading, it releases the hook 140a from the projection 131 of the optical pickup 13 at the disc loading position and unlocks the optical pickup 13.

In the structure shown in FIGS. 1 and 2, when an Eject button (not shown) is pressed to unload the optical disc from the optical disc apparatus 1, the loading motor 40 rotates and the lever members 121 and 122 are driven by the rotary driving power through the transmission 41 and the driving power of the lever member 122 is transmitted through the arm member 143 to the lifting mechanism 170. The lifting mechanism 170 turns the unit mechanical deck 50 around the fulcrum line PP′ to move down the unit mechanical deck member 50 from the height of its loading position in the -Z-axis direction. Concurrently with the movements of the lever members 121 and 122 and the descent of the unit mechanical deck 50 through the lifting mechanism 170, the lever member 122 drives the lever member 123 to turn around the turn fulcrum 123a and consequently the slide arm member 124, connected with it, moves back in the direction opposite to the direction of arrow E. As the slide arm member 124 moves back in this way, it is released from the recessed surface 140d of the lock member 140. When the lock member 140 is released from the slide arm member 124, it turns around the turn fulcrum 140c counterclockwise and engages the hook 140a with the projection 131 of the optical pickup 13 and locks the optical pickup 13.

On the other hand, as the optical disc is inserted into the optical disc apparatus 1 and loaded, the loading motor 40 rotates and the lever members 121 and 122 are driven by the rotary driving power through the transmission 41 and the driving power of the lever member 122 is transmitted through the arm member 143 to the lifting mechanism 170. The lifting mechanism 170 turns the unit mechanical deck 50 around the fulcrum line PP′ to move up the unit mechanical deck member 50 in the Z-axis direction, for example to a position at which the inner circumference of the optical disc touches part of a top case (case which covers the front side of the apparatus) so that the optical disc is chucked onto the surface of the turntable 12. After chucking, the lifting mechanism 170 again turns the unit mechanical deck 50 around the fulcrum line PP′ to move it down in the -Z-axis direction to the height of the specified loading position. Concurrently with these movements, the lever member 122 drives the lever member 123 to turn around the turn fulcrum 123a and consequently the slide arm member 124 moves forward in the direction of arrow E and touches the recessed surface 140d of the lock member 140. When the lock member 140 is in touch with the slide arm member 124, it receives an external force from the slide arm member 124 and turns around the turn fulcrum 140c clockwise; after the above disc loading sequence is completed, namely after the unit mechanical deck 50 comes to the height of the specified loading position, the hook 140a of the lock member 140 is released from the projection 131 of the optical pickup 13 at the disc loading position and unlocks the optical pickup 13. After the optical pickup 13 is unlocked, it is driven by the lead screw 31 which is rotated by the feed motor 30, and guided by the guide members 32 and 33 so that it can move in a virtually radial direction of the optical disc for recording or playback.

The same constituent elements as those shown in FIGS. 1 and 2 are designated by the same reference numerals and symbols as used in FIGS. 1 and 2.

FIG. 3 shows the structure of the lock mechanism A of the optical pickup 13 in the optical disc apparatus 1 shown in FIGS. 1 and 2.

In FIG. 3, numeral 124a represents a tip of the slide arm member 124; 140b an arm of the lock member 140; 140e a spring connection of the lock member 140; arrows E and F directions of movement of the slide arm member 124; and arrows G and H directions of turn of the lock member 140. The lock member 140 is biased in a direction to engage the hook 140a with the projection 131 of the optical pickup 13 by means of a spring 150.

When the optical disc apparatus 1 changes its state from the disc unloading state to the disc loading state, there occurs a transition in the optical pickup 13 from the locked state (FIG. 2) to the unlocked state. In this case, as mentioned earlier, the slide arm member 124 moves in the direction of arrow E (forward) and its tip 124a touches the recessed surface 140d of the lock member 140, which turns the lock member 140 in the direction of arrow G against the resilience of the spring 150 and releases the hook 140a from the projection 131 of the optical pickup 13, thereby unlocking the optical pickup 13. The other way around, when the optical disc apparatus 1 changes its state from the disc loading state to the disc unloading state, there occurs a transition in the optical pickup 13 from the unlocked state to the locked state (FIG. 2). In this case, the slide arm member 124 moves in the direction of arrow F (backward) and its tip 124a moves away from the recessed surface 140d of the lock member 140. As a consequence, the resilience of the spring 150 turns the lock member 140 in the direction of arrow H and engages the hook 140a with the projection 131 of the pickup 13, thereby locking the optical pickup 13.

FIGS. 4A and 4B are flowcharts which explain the operational sequences of the lock mechanism of FIG. 3, where FIG. 4A shows a disc unloading process and FIG. 4B shows a disc loading process.

Referring to FIG. 4A, the disc unloading process is explained below.

(1) When a command to unload an optical disc is given to the optical disc apparatus 1, for example, by pressing the Eject button, the optical disc apparatus 1 starts the loading motor 40 (step S411).

(2) The rotary driving power of the loading motor 40 drives the lifting mechanism 170 through the transmission 41 and lever members 121 and 122 and the lifting mechanism 170 begins to move down the unit mechanical deck 50 from the height of its optical disc loading position (step S412).

(3) The driving power of the loading motor 40 moves the slide arm member 124 in the direction of arrow F (backward) through the transmission 41 and lever members 121, 122 and 123 and releases it from the lock member 140 (step S413).

(4) The lock member 140 turns toward the projection 131 of the optical pickup 13 (in the direction of arrow H) by the resilience of the spring 150 (step S414).

(5) As the hook 140a turns, it engages with the projection 131 of the optical pickup 13 and the optical pickup 13 is locked (step S415). In this locked state, the optical disc is ready to be unloaded.

Referring to FIG. 4B, the disc loading process is explained below.

(1) As an optical disc is inserted into the optical disc apparatus 1, the optical disc apparatus 1 starts the loading motor 40 (step S421).

(2) The rotary driving power of the loading motor 40 drives the lifting mechanism 170 through the transmission 41 and lever members 121 and 122 and the lifting mechanism 170 moves up the unit mechanical deck 50 to let it start chucking the optical disc (step S422).

(3) The driving power transmitted from the lever member 123 through the lever member 122 moves the slide arm member 124 in the direction of arrow E (forward) (step S423).

(4) As the slide are member 124 moves, it touches the recessed surface 140d, which turns the lock member 140 in the direction of arrow G against the resilience of the spring 150 (step S424).

(5) As the lock member 140 turns, the hook 140a is released from the projection 131 of the optical pickup 13 and the optical pickup 13 is unlocked (step S425). As a result, the optical pickup 13 can move in a virtually radial direction of the optical disc.

At the above steps S411 to S415 and S421 to S425, the loading motor 40 is controlled according to control signals from a control means for the optical disc apparatus 1 such as a microcomputer.

According to the above embodiment, the optical disc apparatus has a simple structure which locks the optical pickup when a disc is unloaded and prevents damage to the optical pickup in transportation or a similar situation.

The present invention may be embodied in other forms without departing from the spirit and major features thereof. Therefore, it should be understood that the above embodiment is just illustrative and not restrictive in terms of interpretation of the invention. The scope of the present invention is indicated in the appended claims. Variations and modifications that fall within equivalents of the appended claims are embraced by the claims.

What is claimed is:

1. An optical disc apparatus which records or reproduces information on an optical disc, comprising:
an optical pickup which applies laser light on the optical disc in order to record or reproduce information; and
a lock mechanism which, when the optical disc is unloaded, locks the optical pickup to make it unmovable, and when the optical disc is loaded, unlocks the optical pickup to make it movable,
the lock mechanism including:
a part to be locked which is provided on the optical pickup; and
a lock member which can turn around a fulcrum and has a hook to engage with the part to be locked, and turns when it touches or leaves a sliding member according as an optical disc is loaded or unloaded, wherein, when the sliding member is not in touch with it, the hook turns in a direction to engage with the part to be locked and locks the optical pickup in a specified position, and when the sliding member is in touch with it, the hook turns in a direction to disengage from the part to be locked and unlocks the optical pickup.

2. The optical disc apparatus according to claim 1, wherein the lock member can turn around the fulcrum in a plane virtually parallel to the rotation plane of an optical disc.

3. The optical disc apparatus according to claim 1, wherein the lock member of the lock mechanism is biased by the resilience of an elastic member in a direction which allows the hook to engage with the part to be locked.

4. The optical disc apparatus according to claim 1, wherein the lock member turns when the tip of the sliding member touches or leaves its recessed surface.
